(19) United States
(12) Patent Application Publication
(10) Pub. No.: US 2006/0035154 A1
(43) Pub. Date: Feb. 16, 2006

(54) Electrochemical device having an electrolyte that includes a tetrasiloxane

(76) Inventors: Robert C. West, Madison, WI (US); Khalil Amine, Downers Grove, IL (US); Zhengcheng Zhang, Monona, WI (US); Qingzheng Wang, Bolingbrook, IL (US); Donald R. Vissers, Naperville, IL (US)

Correspondence Address: MARY ELIZABETH BUSH;QUALLION LLC, P.O. BOX 923127, SYLMAR, CA, 91392-3127, US

(21) Appl. No.: 10/971,926

(22) Filed: Oct. 21, 2004

Related U.S. Application Data
(63) Continuation-in-part of application No. 10/810,081, filed on Mar. 25, 2004.
(63) Continuation-in-part of application No. 10/810,019, filed on Mar. 25, 2004.
(63) Continuation-in-part of application No. 10/810,080, filed on Mar. 25, 2004.
(60) Provisional application No. 60/543,951, filed on Feb. 11, 2004.
(60) Provisional application No. 60/543,898, filed on Feb. 11, 2004.
(60) Provisional application No. 60/542,017, filed on Feb. 4, 2004.
(60) Provisional application No. 60/502,017, filed on Sep. 10, 2003.

(51) Int. Cl. H01M 6/18; H01M 10/40; H01M 6/16

(52) U.S. Cl. 429/313; 29/623.1; 429/311; 429/312; 429/317; 429/309; 429/307; 429/302

(57) ABSTRACT

The electrochemical device has an electrolyte that includes one or more tetrasiloxanes. The tetrasiloxanes have a backbone with two central silicons and two terminal silicons. A first one of the silicons is linked to a side chain that includes a poly(alkylene oxide) moiety. A second one of the silicons is linked to a side chain that includes a poly(alkylene oxide) moiety or to a side chain that includes a cyclic carbonate moiety. When each of the central silicons is linked to a side chain that includes a poly(alkylene oxide) moiety, each of the central silicons is directly linked to the poly(alkylene oxide) moiety.

### REFERENCE TO RELATED APPLICATIONS

This application claims priority to U.S. Provisional Patent Application Ser. No. 60/543,951, filed on Feb. 11, 2004 and entitled “Siloxanes” and to U.S. Provisional Patent Application Ser. No. 60/543,898, filed on Feb. 11, 2004 and entitled “Siloxane Based Electrolytes for Use in Electrochemical Devices;” and to U.S. Provisional Patent application Ser. No. 60/542,017, filed on Feb. 4, 2004, entitled “Nonaqueous Electrolyte Solvents for Electrochemical Devices;” and this application is a continuation-in-part of U.S. patent application Ser. No. 10/810,081, filed on Mar. 25, 2004 and entitled “Electrolyte Including Polysiloxane with Cyclic Carbonate Groups,” which claims priority to Provisional U.S. Patent Application Ser. No. 60/502,017, filed on Sep. 10, 2003, and entitled “Electrolyte Including Polysiloxane with Cyclic Carbonate Groups;” and this application is a continuation-in-part of U.S. Provisional patent application Ser. No. 10/810,019, filed on Mar. 25, 2004 and entitled “Polysiloxane for Use in Electrochemical Cells;” and this application is a continuation-in-part of U.S. patent application Ser. No. 10/810,080, filed on Mar. 25, 2004, entitled “Electrolyte Use in Electrochemical Devices;” and this application is a continuation-in-part of U.S. patent application Ser. No. (Not yet assigned), filed concurrently herewith, and entitled “Battery Having Electrolyte Including Organoborate Salt;” and this application is a continuation-in-part of U.S. patent application Ser. No. (Not yet assigned), filed on Oct. 7, 2004 and entitled “Battery Having Electrolyte Including One or More Additives;” each of which is incorporated herein in its entirety.

### STATEMENT REGARDING FEDERALLY SPONSORED RESEARCH OR DEVELOPMENT

This invention was made with United States Government support under NIST ATP Award No. 70NANB043022 awarded by the National Institute of Standards and Technology (NIST). The United States Government has certain rights in this invention pursuant to NIST ATP Award No. 70NANB043022 and pursuant to Contract No. W-31-109-ENG-38 between the United States Government and the University of Chicago representing Argonne National Laboratory, and NIST 144 LM01, Subcontract No. AGT DTD 09/09/02.

### FIELD

The present invention relates to tetrasiloxanes and more particularly to electrochemical devices with electrolytes that include tetrasiloxanes.

### BACKGROUND

The increased demand for lithium batteries has resulted in research and development to improve the safety and performance of these batteries. Many batteries employ organic carbonate electrolytes associated with high degrees of volatility, flammability, and chemical reactivity. A variety of polysiloxane-based electrolytes have been developed to address these issues. However, polysiloxane based electrolytes typically have a low ionic conductivity that limits their use to applications that do not require high rate performance.

### SUMMARY

Novel tetrasiloxanes are disclosed. The tetrasiloxanes have a backbone with two central silicons and two terminal silicons. A first one of the silicons is linked to a first side chain that includes a poly(alkylene oxide) moiety. A second one of the silicons is linked to a second side chain that includes a poly(alkylene oxide) moiety or to a side chain that includes a cyclic carbonate moiety. When each of the central silicons is linked to a side chain that includes a poly(alkylene oxide) moiety, the poly(alkylene oxide) moieties each include an oxygen linked directly to the backbone.

In some instances, a third one of the silicons and a fourth one of the silicons are each linked to entities that each exclude a poly(alkylene oxide) moiety and/or that each exclude a cyclic carbonate moiety. For instance, the third silicon and the fourth silicon can each be linked to side chains that each exclude a poly(alkylene oxide) moiety and/or that each exclude a cyclic carbonate moiety. In some instances, each of the entities linked to the backbone of the tetrasiloxane in addition to the first side chain and the second side chain exclude a poly(alkylene oxide) moiety and/or a cyclic carbonate moiety.

The first silicon and the second silicon can each be terminal silicons. For instance, the tetrasiloxane can be represented by: 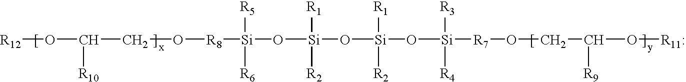
R₁ is an alkyl group; R₂ is an alkyl group; R₃ is an alkyl group or an aryl group; R₄ is an alkyl group or an aryl group; R₅ is an alkyl group or an aryl group; R₆ is an alkyl group or an aryl group; R₇ is nil or a spacer, R₈ is nil or are each a spacer; R₉ is a hydrogen, an alkyl group or an aryl group; R₁₀ is a hydrogen, an alkyl group or an aryl group; R₁₁ is an alkyl group or an aryl group; and R₁₂ is an alkyl group or an aryl group; x is 1 to 12 and y is 1 to 12.

The first silicon and the second silicon can each be central silicons. For instance, the tetrasiloxane can be represented by: 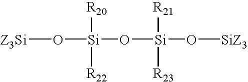
wherein: R₂₀ is an alkyl group or an aryl group; R₂₁ is an alkyl group or an aryl group; R₂₂ is represented by formula II-A; R₂₃ is represented by formula II-B or formula II-C; and each Z is an alkyl or an aryl group.
Formula II-A: 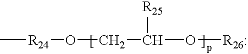
wherein R₂₄ is an organic spacer or nil; R₂₅ is hydrogen, alkyl, or aryl; R₂₆ is alkyl or aryl; and p is 1 to 12.
Formula II-B: 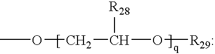
wherein R₂₈ is hydrogen, alkyl or aryl; R₂₉ is alkyl or aryl; and q is 1 to 12.
Formula II-C: 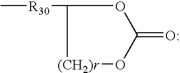
wherein R₃₀ is an organic spacer; and r is 1 or 2.

Electrolytes that include the above siloxanes are also disclosed. The electrolytes include one or more of the above tetrasiloxanes and one or more salts. The electrolytes can optionally include a polymer that interacts with one or more of the siloxanes so as to form an interpenetrating network. The electrolyte can optionally include one or more silanes and/or one or more additives and/or one or more siloxanes having a backbone with more than four silicons or less than four silicons. Additionally or alternately, the electrolyte can optionally include one or more solid polymers that are each a solid polymer when standing alone at room temperature.

Electrochemical devices that employ the electrolytes are also disclosed. The electrochemical devices include one or more anodes and one or more cathodes activated by the electrolyte. Methods of generating the above siloxanes, electrolytes and electrochemical devices are also disclosed.

### BRIEF DESCRIPTION OF THE FIGURES

FIG. 1 illustrates a hydrosilylation reaction suitable for generating the tetrasiloxanes.

FIG. 2 illustrates a dehydrogenation reaction suitable for generating the tetrasiloxanes.

### DESCRIPTION

Electrochemical devices with an electrolyte that includes a tetrasiloxane are disclosed. The tetrasiloxanes have a backbone with two central silicons and two terminal silicons. At least one of these silicons is linked to a side chain that includes a poly(alkylene oxide) moiety. Another of these silicons can be linked to a side chain that includes a poly(alkylene oxide) moiety or a cyclic carbonate moiety. The tetrasiloxanes can be less volatile, flammable and chemically reactive than the organic carbonate electrolytes that are often employed in batteries. Accordingly, electrolytes that include these tetrasiloxanes can be better suited for use as a battery electrolyte than organic carbonates.

The tetrasiloxanes can yield an electrolyte with a lower viscosity than polysiloxane based electrolytes. The reduction in viscosity can improve wetting of electrodes in an electrochemical device enough to enhance the homogeneity of the electrolyte distribution in the cell. Surprisingly, these electrolyte features can be sufficient to enhance the capacity and cycling properties of batteries. As a result, the electrolytes can be suitable for use in batteries such as high-energy and long cycle life lithium secondary batteries, such as biomedical devices, electrical vehicles and satellite applications.

The electrolytes can also have high ionic conductivities in addition to the enhanced capacity and cycling properties. For instance, the tetrasiloxane can include a backbone with two silicons that are each linked to a side chain that includes a poly(alkylene oxide) moiety. The poly(alkylene oxide) moieties can help dissolve lithium salts that are employed in batteries. Accordingly, the tetrasiloxanes can provide an electrolyte with a concentration of free ions suitable for use in batteries. Additionally, the one or more poly(alkylene oxide) moieties can enhance the ionic conductivity of the electrolyte at room temperatures.

In some instances, the tetrasiloxane includes a backbone with one of the silicons linked to a side chain that includes a poly(alkylene oxide) moiety and another of the silicons linked to a side chain that includes a cyclic carbonate moiety. The carbonate moieties can have a high ability to dissolve the salts that are employed in electrolytes. As a result, the carbonates can provide high concentrations of free ions in the electrolyte and can accordingly work in conjunction with the poly(alkylene oxide) moiety to increase the ionic conductivity of the electrolyte.

The electrolyte can also be a solid or a gel. For instance, the electrolyte can include a cross-linked network polymer that forms an interpenetrating network with the tetrasiloxane. An electrolyte that includes an interpenetrating network can be a solid or a gel. Accordingly, the interpenetrating network can serve as a mechanism for providing a solid electrolyte or a gel electrolyte. Alternately, the electrolyte can include one or more solid polymers in addition to the tetrasiloxane. The one or more solid polymers are a solid when standing alone at room temperature. The solid polymer can be employed to generate a gel electrolyte or a solid electrolyte such as a plasticized electrolyte.

A suitable tetrasiloxane includes a backbone having four silicons. The four silicons include two central silicons and two terminal silicons. A first one of the silicons is linked to a first side chain that includes a poly(alkylene oxide) moiety. A second one of the silicons is linked to a second side chain that includes a poly(alkylene oxide) moiety or a cyclic carbonate moiety. In some instances, the first silicon and the second silicon are each terminal silicons. In other instances, the first silicon and the second silicon are each central silicons.

As the number of substituents that include a poly(alkylene oxide) moiety and/or a cyclic carbonate moiety increase, the viscosity of an electrolyte can increase undesirably and/or the ionic conductivity of an electrolyte can decrease undesirably. As a result, the tetrasiloxane can include no more than two poly(alkylene oxide) moieties or no more than one poly(alkylene oxide) moiety. Additionally or alternately, the tetrasiloxane can include no more than two carbonate moieties or no more than one carbonate moiety. For instance, a third one of the silicons and a fourth one of the silicons can each be linked to entities that each exclude a poly(alkylene oxide) moiety and/or that each exclude a cyclic carbonate moiety. For instance, the third silicon and the fourth silicon can each be linked to substituents such as side chains that each exclude a poly(alkylene oxide) moiety and/or that each exclude a cyclic carbonate moiety. In some instances, the entities linked to the backbone of the tetrasiloxane other than the first side chain and the second side chain each exclude a poly(alkylene oxide) moiety and/or a cyclic carbonate moiety. For instance, the entities linked to the backbone of the tetrasiloxane other than the first side chain and the second side chain can each be a substituent such as a side chain and each of these substituents can exclude a poly(alkylene oxide) moiety and/or a cyclic carbonate moiety.

A silicon on the tetrasiloxane backbone can be linked directly to a poly(alkylene oxide) moiety or a spacer can be positioned between the poly(alkylene oxide) moiety and the silicon. A spacer can enhance stability while removing the spacer can reduce viscosity and enhance conductivity. The spacer can be an organic spacer. When the first silicon and the second silicon are each central silicons linked directly to a poly(alkylene oxide) moiety, the poly(alkylene oxide) moieties each include an oxygen linked directly to the backbone. The poly(alkylene oxide) moiety can be an oligo(alkylene oxide) moiety. In some instances, the poly(alkylene oxide) moiety is a poly(ethylene oxide) moiety.

When a silicon is linked to side chains that includes a cyclic carbonate moiety, the side chain can include a spacer that links the carbonate moiety to the silicon or an oxygen can link the cyclic carbonate moiety to the silicon. The spacer can be an organic spacer.

In instances where the first silicon and the second silicons are each terminal silicons, the first and second silicons can each be linked to a side chain that includes a poly(alkylene oxide) moiety. Formula I provides an example of a tetrasiloxane where the first silicon and the second silicon are each terminal silicons linked to a side chain that includes a polyethylene oxide moiety. Formula I: 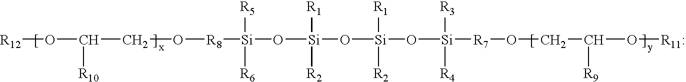
R₁ is an alkyl group; R₂ is an alkyl group; R₃ is an alkyl group or an aryl group; R₄ is an alkyl group or an aryl group; R₅ is an alkyl group or an aryl group; R₆ is an alkyl group or an aryl group; R₇ is nil or a spacer; R₈ is nil or a spacer; R₉ is a hydrogen, an alkyl group or an aryl group; R₁₀ is a hydrogen, an alkyl group or an aryl group; R₁₁ is an alkyl group or an aryl group; and R₁₂ is an alkyl group or an aryl group; x is 1 or greater and/or 12 or less and y is 1 or greater and/or 12 or less. One or more of the alkyl and/or aryl groups can be substituted, unsubstituted, halogenated, and/or fluorinated. The spacers can be organic spacers and can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₇ and R₈ are each nil or are each a spacer. In one example, R₇and/or R₈ is represented by: —(CH₂)₃—. In one example: R₁; R₂; R₃; R₄; R₅; R₆; and R₁₂ are each methyl groups.

Examples of preferred tetrasiloxanes according to Formula I are represented by Formula I-A through Formula I-B. Formula I-A illustrates an example of a tetrasiloxane having terminal silicons linked to side chains that include an organic spacer linking a poly(alkylene oxide) moiety to a terminal silicon. Formula I-B illustrates an example of a tetrasiloxane having terminal silicons that are each linked to an oxygen included in a poly(alkylene oxide) moiety.
Formula I-A: 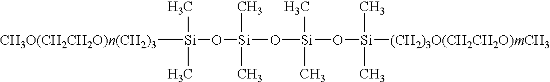
wherein n is 1 to 12 and m is 1 to 12.
Formula I-B: 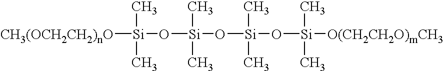
wherein n is 1 to 12 and m is 1 to 12.

Another suitable tetrasiloxane has a backbone with one of two central silicons linked to a side chain that includes a poly(alkylene oxide) moiety and the other central silicon linked to a side chain that includes a poly(alkylene oxide) moiety or a carbonate moiety. When each of the central silicons is linked to a side chain that includes a poly(alkylene oxide) moiety, the poly(alkylene oxide) moieties each include an oxygen linked directly to a silicon in the backbone.

An example of the tetrasiloxane is represented by Formula II.
Formula II: 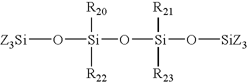
wherein: R₂₀ is an alkyl group or an aryl group; R₂₁ is an alkyl group or an aryl group; R₂₂ is represented by Formula II-A; R₂₃ is represented by Formula II-B or II-C and each Z is an alkyl or an aryl group. The Zs can be the same or can be different.
Formula II-A: 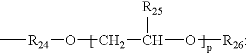
wherein R₂₄ is an organic spacer or nil; R₂₅ is hydrogen, alkyl or aryl; R₂₆ is alkyl or aryl and p is 1 or more and/or 12 or less. The organic spacer and can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₂₄ is represented by: —(CH₂)₃—.
Formula II-B: 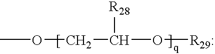
wherein R₂₈ is hydrogen, alkyl or aryl; R₂₉ is alkyl or aryl; q is 1 or more and/or 12 or less.
Formula II-C: 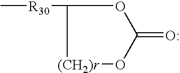
wherein R₃₀ is an organic spacer and r is 1 or 2. Suitable organic spacers for Formula II-A through II-C can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₃₀ is a bivalent ether moiety represented by: —CH₂—O—(CH₂)₃— with the —(CH₂)₃— linked to a silicon on the backbone of the tetrasiloxane. In another example, R₃₀ is an alkylene oxide moiety represented by: —CH₂—O— with the oxygen linked to a silicon on the backbone of the tetrasiloxane.

One or more of the alkyl and aryl groups specified in Formula II through Formula II-C can be substituted, unsubstituted, halogenated, and/or fluorinated. When R₂₃ is according to Formula II-B, R₂₄ can be nil or can be a spacer. In one example, R₂₃ is according to Formula II-C and R₃₀ is represented by: —CH₂—O—(CH₂)₃— where the single —CH₂— group is positioned between the carbonate and the oxygen. In an example, the Zs, R₂₀, R₂₁, R₂₆, and R₂₉ are each a methyl group. In another example, R₂₂ is represented by Formula II-A and R₂₃ is represented by Formula II-B and in another example R₂₃ is represented by Formula II-A and R₂₃ is represented by Formula II-C.

Examples of tetrasiloxanes according to Formula II are represented by Formula II-D through Formula II-F. Formula II-D represents a tetrasiloxane where each of the central silicons is linked to a side chain that includes a poly(ethylene oxide) moiety. The central silicons are each linked directly to an oxygen included in a poly(ethylene oxide) moiety. Formula II-E and Formula I1-F each represent an example of a tetrasiloxane wherein a central silicon is linked to a side chain that includes a poly(alkylene oxide) moiety and another central silicon is linked to a side chain that includes a carbonate moiety. In Formula II-E, an organic spacer is positioned between the poly(alkylene oxide) moiety and the silicon. In Formula I-F, a silicon is linked directly to an oxygen included in a poly(alkylene oxide) moiety.
Formula II-D: 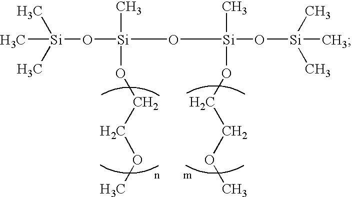
wherein n is 1 to 12.
Formula II-E: 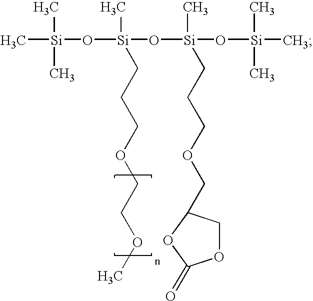
wherein n is 1 to 12.
Formula II-F: 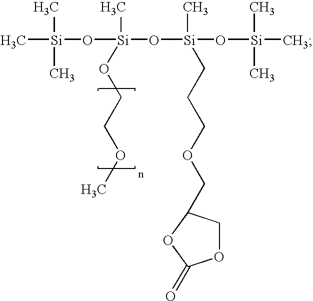
wherein n is 1 to 12.

The electrolyte can include a single tetrasiloxane and none or more other siloxanes. Alternately, the electrolyte can include two or more tetrasiloxanes and none or more other siloxanes. Examples of other suitable siloxanes include, but are not limited to, disiloxanes, trisiloxanes, pentasiloxanes, oligosiloxanes or polysiloxanes. Examples of suitable disiloxanes, trisiloxanes and tetrasiloxanes are disclosed in U.S. Provisional Patent application Ser. No. 60/543,951, filed on Feb. 11, 2004, entitled “Siloxanes;” and in U.S. Provisional Patent application Ser. No. 60/543,898, filed on Feb. 11, 2004, entitled “Siloxane Based Electrolytes for Use in Electrochemical Devices;” and in U.S. Provisional Patent application Ser. No. 60/542,017, filed on Feb. 4, 2004, entitled “Nonaqueous Electrolyte Solvents for Electrochemical Devices;” each of which is incorporated herein in its entirety. Suitable trisiloxanes are disclosed in U.S. patent application Ser. No. (not yet assigned), filed concurrently herewith, entitled “Electrochemical Device Having Electrolyte Including Trisiloxane” and incorporated herein in its entirety. Suitable disiloxanes are disclosed in U.S. patent application Ser. No. (not yet assigned), filed concurrently herewith, entitled “Electrochemical Device Having Electrolyte Including Disiloxane” and incorporated herein in its entirety. In some instances, at least one of the two or more tetrasiloxanes is chosen from those represented by Formula I through Formula II-F. Alternately, each of the tetrasiloxanes can be chosen from those represented by Formula I through Formula II-F.

The electrolyte can also optionally include one or more silanes. Suitable silanes for use in an electrolyte can be substituted. In some instances, the silane includes four organic substituents. The silane can include at least one substituent that includes a moiety selected from a first group consisting of an alkyl group, a halogenated alkyl group, an aryl group, a halogenated aryl group, an alkoxy group, a halogenated alkoxy group, an alkylene oxide group or a poly(alkylene oxide) and at least one substituent that includes a moiety selected from a second group consisting of an alkoxy group, a carbonate group, an alkylene oxide group and a poly(alkylene oxide) group. In some instances, the silane includes four substituents that each includes a moiety selected from the first group or from the second group. The moieties in the first group and in the second group can be substituted or unsubstituted. In some instance, the silane includes one or more substituents that include a halogenated moiety selected from the first group and the second group. The silanes can be silanes selected from the group consisting of aryltrialkoxysilanes and alkyltrialkoxysilanes. Examples of suitable silanes include, but are not limited to, phenyltrimethoxysilane (PTMS), ethyltrimethoxysilane, pentafluorophenyltrimethoxylsilane, and phenethyltris(trimethylsiloxy)silane.

Examples of suitable silanes can be represented by the following Formula III-A through Formula III-C: Formula III-A: 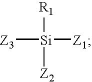
Formula III-B: 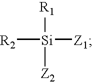
Formula III-C: 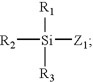
wherein, R₁ is an alkyl, a halogenated alkyl, aryl, halogenated aryl, an alkoxy, a halogenated alkoxy or is represented by Formula III-D; R₂ is an alkyl, a halogenated alkyl, aryl, halogenated aryl, an alkoxy, a halogenated alkoxy or is represented by Formula III-D; R₃ is an alkyl, a halogenated alkyl, aryl, halogenated aryl, an alkoxy, a halogenated alkoxy or is represented by Formula III-D; Z₁ is an alkoxy, a halogenated alkoxy, or is represented by Formula III-E or is represented by Formula III-F; Z₂ is an alkoxy, a halogenated alkoxy, or is represented by Formula III-E or is represented by Formula III-F; Z₃ is an alkoxy, a halogenated alkoxy, or is represented by Formula III-E or is represented by Formula III-F. In instances where more than one of R₁, R₂ and R₃ is represented by Formula III-D, the R₁, R₂ and R₃ represented by Formula III-D can be the same or different. In instances where more than one of Z₁, Z₂ and Z₃ is represented by Formula III-E, the Z₁, Z₂ and Z₃ represented by Formula III-E can be the same or different. In instances where more than one of Z₁, Z₂ and Z₃ is represented by Formula III-F, the Z₁, Z₂ and Z₃ represented by Formula III-F can be the same or different.
Formula III-D: 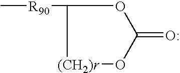
wherein R₉₀ is an organic spacer and r is 1 to 2. Suitable organic spacers can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₉₀ is a bivalent ether moiety represented by: —CH₂—O—(CH₂)₃— with the —(CH₂)₃— linked to the silicon. In another example, R₉₀ is an alkylene oxide moiety represented by: —CH₂—O— with the oxygen linked to the silicon.
Formula III-E: 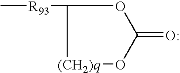
wherein R₉₃ is an organic spacer and q is 1 to 2. Suitable organic spacers can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₉₃ is a bivalent ether moiety represented by: —CH₂—O—(CH₂)₃— with the —(CH₂)₃— linked to the silicon. In another example, R₉₃ is an alkylene oxide moiety represented by: —CH₂—O— with the oxygen linked to the silicon.
Formula III-F: 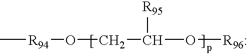
wherein R₉₄ is nil or an organic spacer; R₉₅ is hydrogen; alkyl or aryl; R₉₆ is alkyl or aryl; p is 1 to 12. Suitable organic spacers can include one or more —CH₂— groups. Other suitable spacers can include an alkylene, alkylene oxide or a bivalent ether group. These spacers can be substituted or unsubstituted. The above spacers can be completely or partially halogenated. For instance, the above spacers can be completely or partially fluorinated. In one example, R₉₄ is represented by: —(CH₂)₃—. One or more of the alkyl and aryl groups specified in Formula III through Formula III-F can be substituted, unsubstituted, halogenated, and/or fluorinated.

Other suitable silanes are disclosed in U.S. Provisional Patent Application Ser. No. 60/601,452, filed on Aug. 13, 2004, entitled “Electrolyte Including Silane for Use in Electrochemical Devices,” and incorporated herein in its entirety; and in U.S. patent application Ser. No. 10/810,080, filed on Mar. 25, 2004, entitled “Electrolyte Use in Electrochemical Devices,” and incorporated herein in its entirety.

An electrolyte can be generated by dissolving one or more salts in one or more tetrasiloxanes. In instances where the electrolyte includes a silane and/or another siloxane, one or more of the salts can be dissolved in the silane and/or the other siloxane before the silane is combined with the one or more tetrasiloxanes. Alternately, the one or more salts can be dissolved in a solution that includes one or more silanes and one or more tetrasiloxanes. The electrolyte can be prepared such that the concentration of the salt in the electrolytes is about 0.3 to 2.0 M, about 0.5 to 1.5 M, or about 0.7 to 1.2 M. Suitable salts for use with the electrolyte include, but are not limited to, alkali metal salts including lithium salts. Examples of lithium salts include LiClO₄, LiBF₄, LiAsF₆, LiPF₆, LiCF₃SO₃, Li(CF₃SO₂)₂N, Li(CF₃SO₂)₃C, LiN(SO₂C₂F₅)₂, lithium alkyl fluorophosphates, organoborate salts and mixtures thereof. A preferred salt for use with the electrolyte includes organoborate salts such as lithium bis(oxalato)borate (LiBOB) and lithium difluoro oxalato borate (LiDfOB). Examples of suitable organoborate salts are disclosed in U.S. Patent Application Ser. No. 60/565,211 filed on Apr. 22, 2004, entitled “Organoborate Salt in Electrochemical Device Electrolytes” and incorporated herein in its entirety.

When a lithium salt is used with the electrolyte, an [EO]/[Li] ratio can be used to characterize the salt in the electrolyte. [EO] is the molar concentration in the electrolyte of the ethylene oxides in the one or more tetrasiloxanes. In some instances, spacers and/or silanes will also include ethylene oxides that contribute to the [EO]. The electrolyte is preferably prepared so as to have a [EO]/[Li] ratio of 5 to 50. When the [EO]/[Li] ratio is larger than 50, the ionic conductivity of the resulting electrolyte can become undesirably low because few carrier ions are in the electrolyte. When the [EO]/[Li] ratio is smaller than 5, the lithium salt may not sufficiently dissociate in the resulting electrolyte and the aggregation of lithium ions can confine the ionic conductivity.

In some instances, the electrolyte is generated so as to include one or more additives. Additives can serve a variety of different functions. For instance, additives can enhance the ionic conductivity and/or enhance the voltage stability of the electrolyte. A preferred additive forms a passivation layer on one or more electrodes in an electrochemical device such as a battery or a capacitor. The passivation layer can enhance the cycling capabilities of the electrochemical device. In one example, the passivation layer is formed by reduction of the additive at the surface of an electrode that includes carbon. In another example, the additive forms a polymer on the surface of an electrode that includes carbon. The polymer layer can serve as the passivation layer.

Vinyl ethylene carbonate (VEC) and vinyl carbonate (VC) are examples of additives that can form a passivation layer by being reduced and polymerizing to form a passivation layer. When they see an electron at the surface of a carbonaceous anode, they are reduced to Li₂CO₃ and butadiene that polymerizes at the surface of the anode. Ethylene sulfite (ES) and propylene sulfite (PS) form passivation layers by mechanisms that are similar to VC and VEC. In some instances, one or more of the additives has a reduction potential that exceeds the reduction potential of the components of the electrolyte solvent. For instance, VEC and VC have a reduction potential of about 2.3V. This arrangement of reduction potentials can encourage the additive to form the passivation layer before reduction of other electrolyte solvent components and can accordingly reduce consumption of other electrolyte components.

Suitable additives include, but are not limited to, carbonates having one or more unsaturated substituents. For instance, suitable additives include unsaturated and unsubstituted cyclic carbonates such as vinyl carbonate (VC); cyclic alkylene carbonates having one or more unsaturated substituents such as vinyl ethylene carbonate (VEC), and o-phenylene carbonate (CC, C₇H₄O₃); cyclic alkylene carbonates having one or more halogenated alkyl substituents such as ethylene carbonate substituted with a trifluormethyl group (trifluoropropylene carbonate, TFPC); linear carbonates having one or more unsaturated substituents such as ethyl 2-propenyl ethyl carbonate (C₂H₅CO₃C₃H₅); saturated or unsaturated halogenated cyclic alkylene carbonates such as fluoroethylene carbonate (FEC) and chloroethylene carbonate (CIEC). Other suitable additives include, acetates having one or more unsaturated substituents such as vinyl acetate (VA). Other suitable additives include cyclic alkyl sulfites and linear sulfites. For instance, suitable additives include unsubstituted cyclic alkyl sulfites such as ethylene sulfite (ES); substituted cyclic alkylene sulfites such as ethylene sulfite substituted with an alkyl group such as a methyl group (propylene sulfite, PS); linear sulfites having one or more one more alkyl substituents and dialkyl sulfites such as dimethyl sulfite (DMS) and diethyl sulfite (DES). Other suitable additives include halogenated-gamma-butyrolactones such as bromo-gamma-butyrolactone (BrGBL) and fluoro-gamma-butyrolactone (FGBL).

The additives can include or consist of one or more additives selected from the group consisting of: dimethyl sulfite (DMS), diethyl sulfite (DES), bromo-gamma-butyrolactone (BrGBL), fluoro-gamma-butyrolactone (FGBL), vinyl carbonate (VC), vinyl ethylene carbonate (VEC), ethylene sulfite (ES), o-phenylene carbonate (CC), trifluoropropylene carbonate (TFPC), 2-propenyl ethyl carbonate, fluoroethylene carbonate (FEC), chloroethylene carbonate (ClEC), vinyl acetate (VA), propylene sulfite (PS), 1,3 dimethyl butadiene, styrene carbonate, phenyl ethylene carbonate (PhEC), aromatic carbonates, vinyl pyrrole, vinyl piperazine, vinyl piperidine, vinyl pyridine, and mixtures thereof. In another example, the electrolyte includes or consists of one or more additives selected from the group consisting of vinyl carbonate (VC), vinyl ethylene carbonate (VEC), ethylene sulfite (ES), propylene sulfite (PS), and phenyl ethylene carbonate (PhEC). In a preferred example, the electrolyte includes or consists of one or more additives selected from the group consisting of vinyl carbonate (VC), vinyl ethylene carbonate (VEC), ethylene sulfite (ES), and propylene sulfite (PS). In another preferred example, the electrolyte includes vinyl carbonate (VC) and/or vinyl ethylene carbonate (VEC).

In some conditions, certain organoborate salts, such as LiDfOB, can form a passivation layer. As a result, the desirability and/or concentration of additives may be reduced when organoborate are employed as salts. In some instances, the concentration of additives in the electrolyte generally does not greatly exceed the concentration needed to form the passivation layer. As a result, the additives are generally present in smaller concentrations than salts. A suitable concentration for an additive in the electrolyte includes, but is not limited to, concentrations greater than 0.1 wt %, greater than 0.5 wt % and/or less than 5 wt %, less than 20 wt %, or less than 35 wt % where each of the wt % refers to the percentage of the electrolyte solvent. In a preferred embodiment, the concentration of the additive is less than 3 wt % or less than 2 wt %.

A preferred embodiment of the electrolyte includes or consists of: one or more tetrasiloxanes and an organoborate salt. Another preferred embodiment of the electrolyte includes or consists of: one or more tetrasiloxanes and lithium(oxalato)borate (LiBOB). Another preferred embodiment of the electrolyte includes or consists of: one or more tetrasiloxanes and lithium difluoro oxalato borate (LiDfOB) salt. Another preferred embodiment of the electrolyte includes or consists of: one or more tetrasiloxanes, one or more silanes and an organoborate salt. Another preferred embodiment of the electrolyte includes or consists of: one or more tetrasiloxanes and one or silanes, and lithium difluoro oxalato borate (LiDfOB) salt. Another preferred embodiment of the electrolyte includes or consists of: one or more tetrasiloxanes, one or more silanes, and lithium difluoro oxalato borate (LiDfOB) salt.

A preferred embodiment of the electrolyte includes or consists of: one or more tetrasiloxanes, LiPF₆, and one or more additives selected from a group consisting of VC and VEC. Another preferred embodiment of the electrolyte includes or consists of: one or more tetrasiloxanes, one or more silanes, LiPF₆, and one or more additives selected from a group consisting of VC and VEC.

The electrolyte can include a network polymer that forms an interpenetrating network with the tetrasiloxane. An electrolyte having an interpenetrating network can be generated by polymerizing and/or cross-linking one or more network polymers in the presence of the tetrasiloxane. Alternately, an electrolyte having an interpenetrating network can be generated by polymerizing and/or cross-linking one or more network polymers and the tetrasiloxane in the presence of one another.

Suitable network monomers from which the network polymer can be formed include, but are not limited to, acrylates and methacrylates. Acrylates and/or methacrylates having one or more functionalities can homopolymerize to form a polyacrylate and/or a polymethacrylate network polymer. Acrylates and/or methacrylates having two or more functionalities can both polymerize and cross-link to form a cross-linked polyacrylate network polymer and/or to form a cross-linked polymethacrylate network polymer. In some instances, acrylates and/or methacrylates having four or more functionalities are a preferred network monomer. Suitable acrylates include, but are not limited to, poly(alkylene glycol) dialkyl acrylate. Suitable methacrylates include, but are not limited to, poly(alkylene glycol) dialkyl methacrylate.

A suitable network monomer is represented by the following Formula IV: 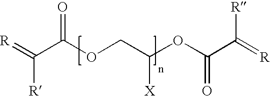
wherein: R is represented by ═CR′″R″″ and each can be the same or different; R′ represents hydrogen or a group selected from an alkyl group having 1 to 10 carbon atoms and/or an alkenyl group having 2 to 12 carbon atoms; R″ represents hydrogen or a group selected from an alkyl group having 1 to 10 carbon atoms or an alkenyl group having 2 to 12 carbon atoms; R′″ represents hydrogen or a group selected from an alkyl group having 1 to 10 carbon atoms; R″″ represents hydrogen or a group selected from an alkyl group having 1 to 10 carbon atoms; X is hydrogen or a methyl group; and n represents a numeral of 1 to 15.

When a monomer that cross-links is employed to form a cross-linked network polymer, a control monomer can be employed to control cross-linking density. A suitable control monomer for use with a network monomer according to Formula IV is represented by the following Formula V: 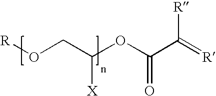
wherein: R is represented by ═CR′″R″″; R′ is an alkyl group having 1 to 10 carbon atoms; R″ is hydrogen or a group selected from an alkyl group having 1 to 10 carbon atoms or an alkenyl group having 2 to 12 carbon atoms; R′″ represents hydrogen or a group selected from an alkyl group having 1 to 10 carbon atoms; R″″ represents hydrogen or a group selected from an alkyl group having 1 to 10 carbon atoms; X is hydrogen or a methyl group; and n represents a whole number from 1 to 20. During formation of the network polymer, the illustrated control monomer serves as a co-monomer with the network monomers according to Formula IV. Because the control monomer does not cross link, increasing the amount of control monomer present during formation of the network polymer can reduce the density of cross linking.

Diallyl terminated compounds can also be employed as a network monomer. Diallyl terminated compounds having two or more functionalities can polymerize and cross-link to form the network polymer. An example of a diallyl terminated compound having two functionalities that allow the compound to polymerize and cross link is represented by Formula VI.
Formula VI: 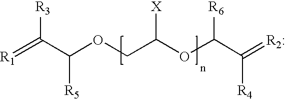
wherein R₁ is represented by ═CR′″R″″, R₂ is represented by ═CR′″R″″; R₃ represents hydrogen or a group selected from an alkyl group having 1 to 10 carbon atoms or an alkenyl group having 2 to 12 carbon atoms; R₄ represents hydrogen or a group selected from an alkyl group having 1 to 10 carbon atoms or an alkenyl group having 2 to 12 carbon atoms; R₅ represents hydrogen or a group selected from an alkyl group having 1 to 10 carbon atoms or an alkenyl group having 2 to 12 carbon atoms; R₆ represents hydrogen or a group selected from an alkyl group having 1 to 10 carbon atoms or an alkenyl group having 2 to 12 carbon atoms; R′″ represents hydrogen or a group selected from an alkyl group having 1 to 10 carbon atoms; R″″ represents hydrogen or a group selected from an alkyl group having 1 to 10 carbon atoms; X is hydrogen or a methyl group; and n represents a numeral of 1 to 15.

Formula VII represents an example of a control monomer for controlling the cross linking density of a compound represented by Formula VI.
Formula VII: 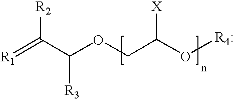
wherein R₁ is represented by ═CR′″R″″, R₂ represents hydrogen or a group selected from an alkyl group having 1 to 10 carbon atoms or an alkenyl group having 2 to 12 carbon atoms; R₃ represents hydrogen or a group selected from an alkyl group having 1 to 10 carbon atoms or an alkenyl group having 2 to 12 carbon atoms; R₄ represents hydrogen or a group selected from an alkyl group having 1 to 10 carbon atoms or an alkenyl group having 2 to 12 carbon atoms; R′″ represents hydrogen or a group selected from an alkyl group having 1 to 10 carbon atoms; R″″ represents hydrogen or a group selected from an alkyl group having 1 to 10 carbon atoms; X is hydrogen or a methyl group; and n represents a numeral of 1 to 15.

A diallyl terminated compound suitable for serving as a network monomer can include more than two functionalities. For instance, the oxygens shown in Formula IV can be replaced with CH₂ groups to provide a diallyl terminated compound having four functionalities that allow the compound to polymerize and cross link. Further, the carbonyl groups shown in Formula V can be replaced with allyl groups to provide an example of a control monomer for controlling the cross linking density of the diallyl terminated compound. Other suitable diallyl terminated compounds for serving as a network monomer include, but are not limited to, poly(alkylene glycol) diallyl ether. A specific examples includes, but is not limited to, tetra(ethylene glycol) diallyl ether.

An electrolyte that includes an interpenetrating network can be formed by generating a precursor solution that includes the one or more tetrasiloxanes, the monomers for forming the cross-linked network polymer and one or more salts. The precursor solution can also optionally be generated so as to include one or more radical initiators, one or more silanes and/or one or more additives. Suitable radical initiators include, but are not limited to, thermal initiators including azo compounds such as azoisobutyronitrile, peroxide compounds such as benzoylperoxide, and bismaleimide. A control monomer can also optionally be added to the precursor solution to control the cross-linking density of the network monomer. The monomers are cross-linked and/or polymerized to form the electrolyte. In some instance, the temperature of the precursor solution is elevated and/or the precursor solution is exposed to UV to form the electrolyte. The resulting electrolyte can be a liquid, solid or gel. The physical state of the electrolyte can depend on the ratio of the components in the precursor solution.

In an electrolyte formed using the monomers represented by Formula IV, the network polymer is formed from a monomer that homopolymerizes and cross-links. Alternately, an electrolyte having an interpenetrating network can be generated from a polymer and a cross-linking agent for cross linking of the polymer. For instance, a diallyl terminated compound can serve as a cross linking agent for a polysiloxane having a backbone that includes one or more silicons linked to a hydrogen. Examples of suitable diallyl terminated cross-linking agents include, but are not limited to, diallyl-terminated siloxanes, diallyl terminated polysiloxanes, diallyl terminated alkylene glycols and diallyl terminated poly(alkylene glycol)s.

The electrolyte can be generated by preparing a precursor solution that includes the polymer, the cross linking agent, the one or more tetrasiloxanes and one or more salts. The precursor solution can also optionally be generated so as to include one or more catalysts, one or more silanes and/or one or more additives. Suitable catalysts include, but are not limited to, platinum catalysts such as Karlstedt's catalyst and H₂PtCl₆. In some instances, an inhibitor is added to the precursor solution to slow the cross-linking reaction enough to permit handling prior to viscosity changing. Suitable inhibitors include, but are not limited to, dibutyl maleate. The polymer is cross-linked to form the electrolyte. In some instances, heat and/or UV energy is also applied to the precursor solution during the reaction of the cross linking precursor and the cross-linking agent.

A network polymer suitable for the interpenetrating network can be formed using other precursors. For instance, the network polymer can be generated from a mixture of monomers and cross-linking agents that are different from one another. The monomers can polymerize and the cross-linking agents can provide cross linking of the resulting polymer. In another example, monomers that heteropolymerize are employed to generate the network polymer. Other examples of methods for generating electrolytes and electrochemical devices that include network polymers are described in U.S. patent application Ser. No. 10/104,352, filed on Mar. 22, 2002, entitled “Solid Polymer Electrolyte and Method of Preparation” and incorporated herein by reference in its entirety.

As noted above, the electrolyte can include one or more solid polymers in addition to the tetrasiloxane. The solid polymers are each a solid when standing alone at room temperature. As a result, the ratio of solid polymer to the other electrolyte components can be selected so as to provide an electrolyte that is a solid at room temperature. A suitable solid polymer is an aprotic polar polymer or aprotic rubbery polymer. Examples of suitable solid polymers include, but are not limited to, polyacrylonitrile (PAN), poly(methyl methacrylate) (PMMA), poly(vinylidene fluoride) (PVDF), poly(vinylidene fluoride-co-hexafluoropropylene), polystyrene, polyvinyl chloride, poly(alkyl methacrylate), poly(alkyl acrylate), styrene butadiene rubber (SBR), poly(vinyl acetate), poly(ethylene oxide) (PEO) and mixtures thereof.

The electrolyte can be generated by preparing a precursor solution that includes one or more tetrasiloxanes and a solution that includes a solid polymer. The solution that includes the solid polymer can be generated by dissolving the solid polymer in a solvent such as N-methylpyrrolidone (NMP), dimethyl formamide, dimethyl acetamide, tetrahydrofuran, acetonitrile, and/or water. One or more additives and/or one or more other siloxanes and/or one or more silanes can also be optionally added to the precursor solution. One or more salts can be added to the precursor solution or the salt can be dissolved in a component of the precursor solution before adding the component to the precursor solution. A solid electrolyte can be formed by evaporating the solvent from the precursor solution.

An electrolyte that includes one or more solid polymers can also be generated by polymerizing a solid polymer in the presence of the tetrasiloxane. For instance, a precursor solution can be generated so as to include one or more tetrasiloxanes, monomers for the solid polymer and a radical initiator. Suitable radical initiators include, but are not limited to, thermal initiators including azo compounds such as azoisobutyronitrile, peroxide compounds such as benzoylperoxide, and bismaleimide. The precursor solution can optionally be prepared so as to inlucde one or more additives and/or one or more silanes. One or more salts can be added to the precursor solution or the salt can be dissolved in a component of the precursor solution before adding the component to the precursor solution. The electrolyte can be formed by polymerizing the monomers. As an example, acrylonitrile monomers can be mixed with the tetrasiloxane. The acrylonitrile monomers can be polymerized by the application of heat and/or UV to form an electrolyte having a polyacrylonitrile solid polymer.

As is evident from the above discussion, the electrolyte can include components in addition to the one or more tetrasiloxanes. For instance, the electrolyte can include other siloxanes, salts, additives, network polymers, solids polymers and/or silanes. In some instances, the electrolyte is generated such that the one or more tetrasiloxanes are more than 0.1 wt % of the electrolyte, more than 5 wt % of the electrolyte, more than 20 wt % of the electrolyte, more than 50 wt % of the electrolyte, more than 80 wt % of the electrolyte or more than 95 wt % of the electrolyte. Also, in some instances, the electrolyte consists of one or more tetrasiloxanes and one or more salts. In some instances, the electrolyte consists of one or more tetrasiloxanes, one or more silanes and one or more salts. In some instances, the electrolyte consists of one or more tetrasiloxanes, one or more additives and one or more salts.

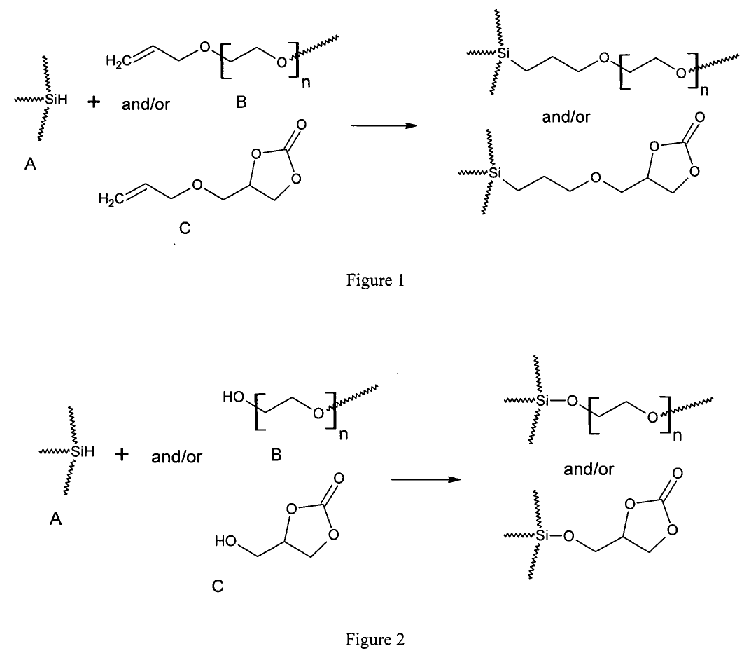

The tetrasiloxanes can be generated by employing a hydrosilylation reaction with a precursor tetrasiloxane and side chain precursors. The precursor tetrasiloxane has one or more hydrogens linked to the silicon(s) where the side chains are desired. The side chain precursor is allyl terminated. The side chain precursors also include a poly(alkylene oxide) moiety or a carbonate moiety. For the purposes of illustration, FIG. 1 illustrates a hydrosilylation reaction employed to generate a tetrasiloxane having one or more side chains that include a poly(ethylene oxide) moiety and/or one or more side chains that includes a carbonate moiety. A precursor tetrasiloxane having a silicon linked to a hydrogen is labeled A. The hydrogen is linked to the silicon where the side chain is desired. An allyl terminated side chain precursor that includes a poly(ethylene oxide) moiety is labeled B and an allyl terminated side chain precursor that includes a cyclic carbonate moiety is labeled C. Although the precursor tetrasiloxane is illustrated as having a single silicon linked to a hydrogen, when two side chains are to be added to a precursor tetrasiloxane, the precursor tetrasiloxane can include two or more hydrogens linked to a silicon in the backbone of the precursor tetrasiloxane or can include one or more hydrogens linked to each of the silicons in the backbone. As is evident from FIG. 1, the hydrosilylation reaction is suitable for generating a tetrasiloxane having a side chain with a spacer between a silicon and a poly(alkylene oxide) moiety or a between a silicon and a carbonate moiety.

When the desired tetrasiloxane has one or more side chains that include a poly(ethylene oxide) moiety, a precursor solution is generated that includes the precursor tetrasiloxane and the side chain precursor labeled B. When the desired tetrasiloxane has one or more side chains that include a carbonate moiety, a precursor solution is generated that includes the precursor tetrasiloxane and the side chain precursor labeled C. When the desired tetrasiloxane has one or more side chains that include a poly(ethylene oxide) moiety and one or more side chains that include a carbonate moiety, the precursor tetrasiloxane, a precursor solution is generated that includes the precursor tetrasiloxane, the side chain precursor labeled B and the side chain precursor labeled C.

In some instances, a reaction solvent is added to the precursor solution of FIG. 1. A suitable solvent includes, but is not limited to, toluene, THF, and benzene. A catalyst can be added to the precursor solution to catalyze the hydrosilylation reaction. Suitable catalysts for use in the precursor solution include, but are not limited to, platinum catalysts such as Karstedt's catalyst (divinyltetramethyldisiloxane (Pt(dvs)), dicyclopentadiene platinum(II) dichloride, H₂PtCl₆. In some instances, heat is applied to the precursor solution to react the components of the precursor solution. The reaction can be continued until the Si—H groups are no longer evident on an FTIR spectrum. The product solution can be distilled to remove any unreacted side-chain precursors and/or reaction solvent. In some instances, the product is decolorized and/or purified by distillation. The product can be decolorized by activated charcoal in refluxing toluene. The product can be purified by distillation using a long vacuum-jacketed Vigreux column and/or by sequentially performing two or more regular distillations. The regular distillations can be vacuum distillations. When a sequence of two or more regular distillations is performed, a central fraction of the distillate can be used as the product for each distillation step.

The tetrasiloxanes can also be generated using a dehydrogenation reaction between a precursor tetrasiloxane and side-chain precursors. The precursor tetrasiloxane has one or more hydrogens linked to the silicon(s) where the side chain(s) are desired. A suitable side chain precursor includes a poly(alkylene oxide) moiety and a terminal —OH group or a cyclic carbonate moiety and a terminal —OH group.

FIG. 2 provides an example of a method for employing dehydrogenation to generate a tetrasiloxane having a side chain(s) that include a poly(alkylene oxide) moiety and/or a side chain(s) that include a carbonate moiety. A precursor tetrasiloxane having at least one silicon linked to a hydrogen is labeled A. The hydrogen is linked to a silicon where a side chain is desired. An —OH terminated side chain precursor that includes a poly(ethylene oxide) moiety is labeled B and an —OH terminated side chain precursor that includes a cyclic carbonate moiety is labeled C. A precursor solution is generated that includes the precursor tetrasiloxane and the side chain precursor labeled B and/or the side chain precursor labeled C. Although the precursor tetrasiloxane is illustrated as having a single silicon linked to a hydrogen, when two side chains are to be added to a precursor tetrasiloxane, the precursor tetrasiloxane can include two or more hydrogens linked to a silicon in the backbone of the precursor tetrasiloxanes or can include one or more hydrogens linked to each of the silicons in the backbone. As is evident from FIG. 2, the dehydrogenation reaction is suitable for generating a tetrasiloxane having a silicon that is directly linked to an oxygen included in a poly(alkylene oxide) moiety.

When the desired tetrasiloxane has one or more side chains that include a poly(ethylene oxide) moiety, a precursor solution is generated that includes the precursor tetrasiloxane and the side chain precursor labeled B. When the desired tetrasiloxane has one or more side chains that include a carbonate moiety, a precursor solution is generated that includes the precursor tetrasiloxane and the side chain precursor labeled C. When the desired tetrasiloxane has one or more side chains that include a poly(ethylene oxide) moiety and one or more side chains that include a carbonate moiety, the precursor tetrasiloxane, a precursor solution is generated that includes the precursor tetrasiloxane, the side chain precursor labeled B and the side chain precursor labeled C.

In some instances, a reaction solvent is added to the precursor solution of FIG. 2. A suitable solvent includes, but is not limited to, Toluene. In some instances, a catalyst is added to the precursor solution to catalyze the dehydrogenation reaction. Suitable catalysts for use in the precursor solution include, but are not limited to, B(C₆F₅)₃, K₂CO₃, N(C₂H₅)₃, Rhodium catalyst (Rh(Ph₃P)₃Cl) and/or Palladium catalyst (Pd₂(dba)₃). In some instances, heat is applied to the precursor solution to react the components of the precursor solution. The reaction can be continued until the Si—H groups are no longer evident on an NMR spectrum. The product solution can be distilled to remove any unreacted side-chain precursors and/or reaction solvent. In some instances, the product is decolorized and/or purified by distillation. The product can be decolorized by activated charcoal in refluxing toluene. The product can be purified by distillation using a long vacuum-jacketed Vigreux column and/or by sequentially performing two or more regular distillations. The regular distillations can be vacuum distillations. When a sequence of two or more regular distillations is performed, a central fraction of the distillate can be used as the product for each distillation step.

The hydrosilylation reaction and/or the dehydrogenation reactions disclosed in the context of FIG. 1 and FIG. 2, can be adapted to generate the above silanes by substituting a precursor silane for the precursor tetrasiloxanes labeled A in FIG. 1 and FIG. 2. Suitable precursor silanes have one or more hydrogens linked to the silicon.

### EXAMPLE 1

A hydrosilylation reaction was employed to generate a siloxane according to Formula I-A with m=3 and n=3. Tri(ethylene glycol) allyl methyl ether (48.96 g, 20% excess) and 1,1,3,3,5,5,7,7-octamethyltetrasiloxane (28.26 g, Gelest, Inc.) were added to an oven-dried flask. While the mixture was stirred vigorously, 100 μL of Karstedt's catalyst (3% wt. solution in xylene, Aldrich Chem Co.) was injected via syringe. The mixture was heated to 75° C. Aliquots were taken periodically and the hydrosilylation reaction was monitored by ¹H-NMR measurements. Excess tri(ethylene glycol) allyl methyl ether and its isomers were removed by Kugelrohr distillation to generate a liquid which was decolorized by activated charcoal in refluxing toluene. The structure was confirmed by ¹H NMR and FTIR.

### EXAMPLE 2

A dehydrogenation reaction was employed to generate a siloxane according to Formula I-B with m=3 and n=3. Tri(ethylene glycol) methyl ether (39.36 g, vacuum distilled prior to use), 1,1,3,3,5,5,7,7-octamethyltetrasiloxane (28.26 g, Gelest, Inc.) and 80 ml of toluene (distilled over Na and benzophenone prior to use) were added to a flame-dried 250 mL Schlenk flask under nitrogen atmosphere. To this solution was added 0.050 g (0.05 mol % of Si—H) of tri(pentafluorophenyl)borane (B(C₆F₅)₃) in toluene. The reaction mixture was heated to and vigorously stirred at 80° C. Bubbling was observed. Aliquots were taken periodically and the dehydrogenation reaction was monitored by FTIR measurements. The absence of Si—H absorption at ˜2170 cm⁻¹ on the IR spectra signaled the completion of the reaction. After the reaction was complete, excess tri(ethylene glycol) methyl ether and the solvent were removed by Kugelrohr distillation. The product structure was confirmed by NMR and FTIR.

### EXAMPLE 3

A hydrosilylation reaction was employed to generate a siloxane according to Formula II-E with m=3 and n=3. Tri(ethylene glycol) allyl methyl ether (n=24.48 g, 20% excess), allyl carbonate (18.96 g, 20% excess) and 1,3-bis(trimethylsiloxy)-1,3-dimethyldisiloxane (28.26 g, Gelest, Inc.) were added to an oven-dried flask. While the mixture was stirred vigorously, 100 μL of Karstedt's catalyst (3% wt. solution in xylene, Aldrich Chem Co.) was injected via a syringe. The reaction mixture was then heated to 75° C. Aliquots were taken periodically and the hydrosilylation reaction was monitored by ¹H-NMR measurements. Excess tri(ethylene glycol) allyl methyl ether and its isomers were removed by Kugelrohr distillation to generate a liquid which was decolorized by activated charcoal in refluxing toluene. The structure was confirmed by ¹H NMR and FTIR.

### EXAMPLE 4

A lithium cell could be prepared with a Li metal anode and a cathode activated by an electrolyte having lithium bis(oxalato)borate (LiBOB) dissolved to 0.8 M in the tetrasiloxane of Example 1, Example 2 and/or Example 3. The composition of the cathode could be 84 wt % LiNi_{0.8}Co_{0.15}Al_{0.05}O₂, 8 wt % PVDF binder, 4 wt % SFG-6 graphite and 4 wt % carbon black. The effective cell area could be 1.6 cm².

### EXAMPLE 5

A lithium secondary could be prepared with an anode and a cathode activated by an electrolyte having lithium bis(oxalato)borate (LiBOB) dissolved to 0.8 M in the tetrasiloxane of Example 1, Example 2 and/or Example 3. The composition of the cathode could be 84wt % LiNi_{0.8}Co_{0.15}Al_{0.05}O₂, 8 wt % PVDF binder, 4 wt % SFG-6 graphite and 4 wt % carbon black. The composition of the anode could be 92 wt % MCMB and 8 wt % PVDF binder. The effective cell area could be 1.6 cm².

The electrolytes described above can be used in electrochemical devices such as primary batteries, secondary batteries and capacitors. Suitable batteries can have a variety of different configurations including, but not limited to, stacked configuration, and “jellyroll” or wound configurations. In some instances, the battery is hermetically sealed. Hermetic sealing can reduce entry of impurities into the battery. As a result, hermetic sealing can reduce active material degradation reactions due to impurities. The reduction in impurity induced lithium consumption can stabilize battery capacity.

The electrolyte can be applied to batteries in the same way as carbonate-based electrolytes. As an example, batteries with a liquid electrolyte can be fabricated by injecting the electrolyte into a spiral wound cell or prismatic type cell. The electrolyte can be also coated onto the surface of electrode substrates and assembled with a porous separator to fabricate a single or multi-stacked cell that can enable the use of flexible packaging.

The solid and/or gel electrolytes described above can also be applied to electrochemical devices in the same way as solid carbonate-based electrolytes. For instance, a precursor solution having components for a solid electrolyte can be applied to one or more substrates. Suitable substrates include, but are not limited to, anode substrates, cathode substrates and/or separators such as a polyolefin separator, nonwoven separator or polycarbonate separator. The precursor solution is converted to a solid or gel electrolyte such that a film of the electrolyte is present on the one or more substrates. In some instances, the substrate is heated to solidify the electrolyte on the substrate. An electrochemical cell can be formed by positioning a separator between an anode and a cathode such that the electrolyte contacts the anode and the cathode.

An example of a suitable secondary lithium battery construction includes the electrolyte activating one or more cathodes and one or more anodes. Cathodes may include one or more active materials such as lithium metal oxide, LiₓVO_{y}, LiCoO₂, LiNiO₂, LiNi₁₋ₓCo_{y}Me₂O₂, LiMn_{0.5}Ni_{0.5}O₂, LiMn_{0.3}Co_{0.3}Ni_{0.3}O₂, LiFePO₄, LiMn₂O₄, LiFeO₂, LiFeO₂, LiMc_{0.5}Mn_{1.5}O₄, vanadium oxide, carbon fluoride and mixtures thereof wherein Me is Al, Mg, Ti, B, Ga, Si, Mn, Zn, and combinations thereof, and Mc is a divalent metal such as Ni, Co, Fe, Cr, Cu, and combinations thereof. Anodes may include one or more active materials such as graphite, soft carbon, hard carbon, Li₄Ti₅O₁₂, tin alloys, silica alloys, intermetallic compounds, lithium metal, lithium metal alloys, and combinations thereof. An additional or alternate anode active material includes a carbonaceous material or a carbonaceous mixture. For instance, the anode active material can include or consist of one, two, three or four components selected from the group consisting of: graphite, carbon beads, carbon fibers, and graphite flakes. In some instances, the anode includes an anode substrate and/or the cathode includes a cathode substrate. Suitable anode substrates include, but are not limited to, lithium metal, titanium, a titanium alloy, stainless steel, nickel, copper, tungsten, tantalum or alloys thereof. Suitable cathode substrates include, but are not limited to, aluminum, stainless steel, titanium, or nickel substrates.

Suitable anode constructions are provided in U.S. Provisional Patent Application Ser. No. 60/563,848, filed on Apr. 19, 2004, entitled “Battery Having Anode Including Lithium Metal;” and in U.S. Provisional Patent Application Ser. No. 60/563,849, filed on Apr. 19, 2004, entitled “Battery Employing Electrode Having Graphite Active Material;” and in U.S. patent application Ser. No. 10/264,870, filed on Oct. 3, 2002, entitled “Negative Electrode for a Nonaqueous Battery;” which claims priority to U.S. Provisional Patent Application Ser. No. 60/406,846, filed on Aug. 29, 2002, entitled “Negative Electrode for a Nonaqueous Battery;” each of which is incorporated herein in its entirety.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

We claim:

1. An electrochemical device, comprising:
an electrolyte including a tetrasiloxane having a backbone with two central silicons and two terminal silicons:
a first one of the silicons being linked to a side chain that includes a poly(alkylene oxide) moiety;
a second one of the silicons being linked to a side chain that includes a poly(alkylene oxide) moiety or to a side chain that includes a cyclic carbonate moiety; and
each of the central silicons being directly liked to the poly(alkylene oxide) moiety when each of the central silicons is linked to a side chain that includes a poly(alkylene oxide) moiety.

2. The device of claim 1, wherein a third one of the silicons and a fourth one of the silicons are each linked to side chains that each exclude a poly(alkylene oxide) moiety.

3. The device of claim 1, wherein a third one of the silicons and a fourth one of the silicons are each linked to side chains that each exclude a cyclic carbonate moiety.

4. The device of claim 1, wherein a third one of the silicons and a fourth one of the silicons are each linked to side chains that each exclude both a cyclic carbonate moiety and a poly(alkylene oxide) moiety.

5. The device of claim 1, wherein the first silicon is a terminal silicon and the second silicon is a terminal silicon.

6. The device of claim 5, wherein the first silicon is linked directly to an oxygen included in the poly(alkylene oxide) moiety.

7. The device of claim 5, wherein the side chain linked to the first silicon includes an organic spacer positioned between the first silicon and the poly(alkylene oxide) moiety.

8. The device of claim 5, wherein the tetrasiloxane is represented by: 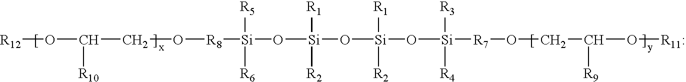
wherein R₁ is an alkyl group; R₂ is an alkyl group; R₃ is an alkyl group or an aryl group; R₄ is an alkyl group or an aryl group; R₅ is an alkyl group or an aryl group; R₆ is an alkyl group or an aryl group; R₇ is nil or a spacer, R₈ is nil or a spacer; R₉ is a hydrogen, an alkyl group or an aryl group; R₁₀ is a hydrogen, an alkyl group or an aryl group; R₁₁ is an alkyl group or an aryl group; and R₁₂ is an alkyl group or an aryl group; x is 1 to 12 and y is 1 to 12.

9. The device of claim 8, wherein R₁; R₂; R₃; R₄; R₅; R₆; R₁₁; and R₁₂ are each methyl groups.

10. The device of claim 8, wherein R₇ and R₈ are each nil.

11. The device of claim 8, wherein R₇ and R₈ are each an organic spacer.

12. The device of claim 5, wherein the tetrasiloxane is represented by: 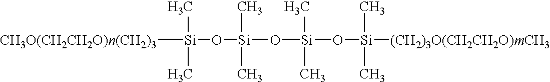
wherein n is 1 to 12 and m is 1 to 12.

13. The device of claim 5, wherein the tetrasiloxane is represented by: 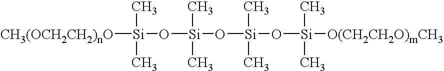
wherein n is 1 to 12 and m is 1 to 12.

14. The device of claim 1, wherein the first silicon is a central silicon and the second silicon is a central silicon.

15. The device of claim 14, wherein the tetrasiloxane is represented by: 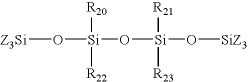
wherein:
R₂₀ is an alkyl group or an aryl group; R₂₁ is an alkyl group or an aryl group; R₂₂ is represented by formula II-A; R₂₃ is represented by formula II-B or formula II-C; and each Z is an alkyl or an aryl group;
formula II-A: 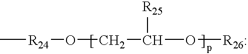
wherein R₂₄ is an organic spacer or nil; R₂₅ is hydrogen, alkyl, or aryl; R₂₆ is alkyl or aryl; and p is 1 to 12;
formula II-B: 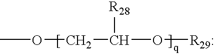
wherein R₂₈ is hydrogen, alkyl or aryl; R₂₉ is alkyl or aryl; and q is 1 to 12;
formula II-C: 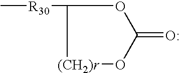
wherein R₃₀ is an organic spacer; and r is 1 or 2.

16. The device of claim 14, wherein the second silicon is linked to a side chain that includes a cyclic carbonate moiety.

17. The device of claim 16, wherein an organic spacer links the poly(alkylene oxide) moiety to the first silicon.

18. The device of claim 16, wherein the first silicon is linked directly to the poly(alkylene oxide) moiety.

19. The device of claim 16, wherein the tetrasiloxane is represented by: 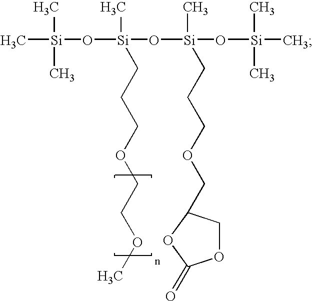
wherein n is 1 to 12.

20. The device of claim 16, wherein the tetrasiloxane is represented by: 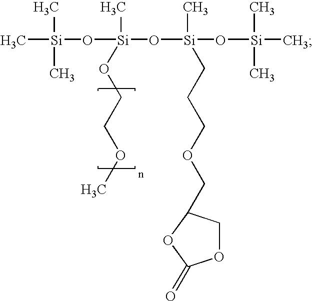
wherein n is 1 to 12.

21. The device of claim 14, wherein the second silicon is linked to a side chain that includes a poly(alkylene oxide) moiety.

22. The device of claim 1, wherein the electrolyte includes an alkali metal salt.

23. The device of claim 22, wherein a concentration of the alkali metal salt in the electrolyte is in a range of 0.3 M to 2.0 M.

24. The device of claim 1, wherein the electrolyte includes an organoborate salt.

25. The device of claim 1, further comprising:
at least one cathode, at least one porous separator and at least one anode.

26. The device of claim 25, wherein the cathode includes a lithium metal oxide and the anode includes at least one material selected from a group consisting of carbon and lithium metal.

27. The device of claim 25, wherein the anode includes a lithium metal and the electrolyte includes an organoborate salt.

28. The device of claim 1, wherein the electrolyte is a liquid.

29. The device of claim 1, wherein the electrolyte is a solid or a gel.

30. The device of claim 1, wherein the electrolyte includes the tetrasiloxane entrapped within a network polymer.

31. The device of claim 30, wherein the network polymer is a product of polymerizing a dialkyl acrylate, a dimethacrylate, a dialkyl methacrylate or a diallyl terminated compound.

32. The device of claim 1, wherein the electrolyte includes a solid polymer.

33. The device of claim 32, wherein the solid polymer is selected from a group consisting of: polyacrylonitrile (PAN), poly(methyl methacrylate) (PMMA), poly(vinylidene fluoride) (PVdF), poly(vinylidene fluoride-co-hexafluoropropylene), poly(vinyl acetate), polystyrene, poly(ethylene oxide) (PEO).

34. The device of claim 1, wherein the electrochemical device includes an anode and the electrolyte includes an additive selected to form a passivation layer on the electrode.

35. The device of claim 1, wherein the electrochemical device includes an anode and the electrolyte includes an additive selected such that the additive is reduced at the surface of the anode so as to form a passivation layer on the anode.

36. The device of claim 1, wherein the electrochemical device includes an anode and the electrolyte includes an additive selected so as to polymerize such that a passivation layer is formed on the anode.

37. The device of claim 1, wherein the electrolyte includes at least one additive selected from the group consisting of: vinyl carbonate, vinyl ethylene carbonate, ethylene sulfite, 1,3 dimethyl butadiene, styrene carbonate, aromatic carbonates, vinyl pyrrole, vinyl piperazine, vinyl piperidine, vinyl pyridine, and mixtures thereof.

38. The device of claim 1, wherein the electrolyte includes one or more additives selected from the group consisting of vinyl carbonate (VC) and vinyl ethylene carbonate (VEC).

39. The device of claim 1, wherein the tetrasiloxane is more than 50 wt % of the electrolyte.

40. An electrochemical device, comprising:
an electrolyte including a tetrasiloxane selected from the group of tetrasiloxanes represented by formula I and formula II:
formula I: 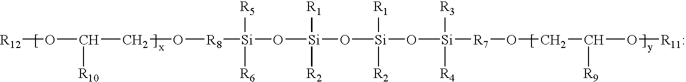
wherein R₁ is an alkyl group; R₂ is an alkyl group; R₃ is an alkyl group or an aryl group; R₄ is an alkyl group or an aryl group; R₅ is an alkyl group or an aryl group; R₆ is an alkyl group or an aryl group; R₇ is nil or a spacer, R₈ is nil or are each a spacer; R₉ is a hydrogen, an alkyl group or an aryl group; R₁₀ is a hydrogen, an alkyl group or an aryl group; R₁₁ is an alkyl group or an aryl group; and R₁₂ is an alkyl group or an aryl group; x is 1 to 12 and y is 1 to 12; and
formula II: 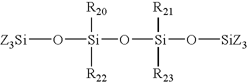
wherein: R₂₀ is an alkyl group or an aryl group; R₂₁ is an alkyl group or an aryl group; R₂₂ is represented by formula II-A; R₂₃ is represented by formula II-B or formula II-C; and each Z is an alkyl or an aryl group;
formula II-A: 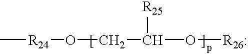
wherein R₂₄ is an organic spacer or nil; R₂₅ is hydrogen, alkyl, or aryl; R₂₆ is alkyl or aryl; and p is 1 to 12;
formula II-B: 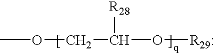
wherein R₂₈ is hydrogen, alkyl or aryl; R₂₉ is alkyl or aryl; and q is 1 to 12;
formula II-C: 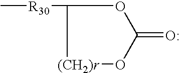
wherein R₃₀ is an organic spacer; and r is 1 or 2.

41. The device of claim 40, wherein the tetrasiloxane is selected from the group consisting of tetrasiloxanes represented by formula I.

42. The device of claim 40, wherein the tetrasiloxane is selected from the group consisting of tetrasiloxanes represented by formula II.

43. A method of forming an electrochemical device, comprising:
generating an electrolyte including a tetrasiloxane having a backbone with two central silicons and two terminal silicons,
a first one of the silicons being linked to a side chain that includes a poly(alkylene oxide) moiety,
a second one of the silicons being linked to a side chain that includes a poly(alkylene oxide) moiety or to a side chain that includes a cyclic carbonate moiety, and
each of the central silicons being directly to the poly(alkylene oxide) moiety when each of the central silicons is linked to a side chain that includes a poly(alkylene oxide) moiety; and
activating at least one anode and at least one cathode with the electrolyte.

44. The method of claim 43, wherein the remaining two of the silicons are linked to side chains that each exclude cyclic carbonate moieties.

45. The method of claim 43, wherein the first silicon is a terminal silicon and the second silicon is a terminal silicon.

46. The method of claim 45, wherein the tetrasiloxane is represented by: 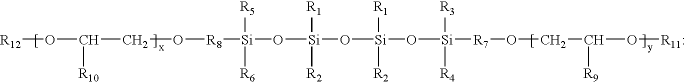
wherein R₁ is an alkyl group; R₂ is an alkyl group; R₃ is an alkyl group or an aryl group; R₄ is an alkyl group or an aryl group; R₅ is an alkyl group or an aryl group; R₆ is an alkyl group or an aryl group; R₇ is nil or a spacer, R₈ is nil or are each a spacer; R₉ is a hydrogen, an alkyl group or an aryl group; R₁₀ is a hydrogen, an alkyl group or an aryl group; R₁₁ is an alkyl group or an aryl group; and R₁₂ is an alkyl group or an aryl group; x is 1 to 12 and y is 1 to 12.

47. The method of claim 45, wherein the tetrasiloxane is represented by: 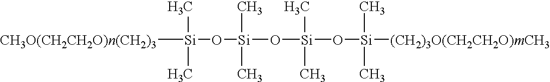
wherein n is 1 to 12 and m is 1 to 12.

48. The method of claim 45, wherein the tetrasiloxane is represented by: 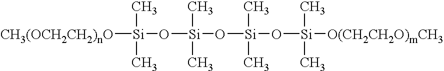
wherein n is 1 to 12 and m is 1 to 12.

49. The method of claim 43, wherein the first silicon is a central silicon and the second silicon is a central silicon.

50. The method of claim 49, wherein the tetrasiloxane is represented by: 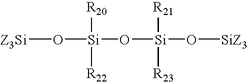
wherein:
R₂₀ is an alkyl group or an aryl group; R₂₁ is an alkyl group or an aryl group; R₂₂ is represented by formula II-A; R₂₃ is represented by formula II-B or formula II-C; and each Z is an alkyl or an aryl group;
formula II-A: 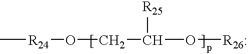
wherein R₂₄ is an organic spacer or nil; R₂₅ is hydrogen, alkyl, or aryl; R₂₆ is alkyl or aryl; and p is 1 to 12;
formula II-B: 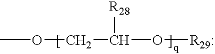
wherein R₂₈ is hydrogen, alkyl or aryl; R₂₉ is alkyl or aryl; and q is 1 to 12;
formula II-C: 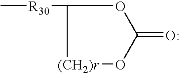
wherein R₃₀ is an organic spacer; and r is 1 or 2.

51. The method of claim 49, wherein the tetrasiloxane is represented by: 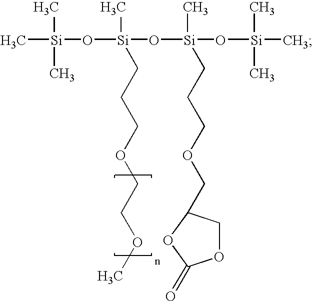
wherein n is 1 to 12.

52. The method of claim 49, wherein the tetrasiloxane is represented by: 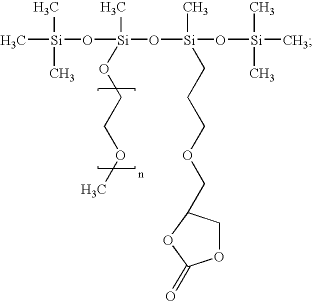
wherein n is 1 to 12.
